(19) United States
(12) Patent Application Publication
(10) Pub. No.: US 2004/0091392 A1
(43) Pub. Date: May 13, 2004

(54) Method and apparatus for employing a tunable microfluidic device for optical switching, filtering and assaying of biological samples

(76) Inventors: Sterling Eduard McBride, Princeton, NJ (US); Peter John Zanzucchi, Princeton Junction, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(21) Appl. No.: 10/638,111

(22) Filed: Aug. 8, 2003

Related U.S. Application Data
(60) Provisional application No. 60/402,477, filed on Aug. 9, 2002.
(60) Provisional application No. 60/402,321, filed on Aug. 9, 2002.

(51) Int. Cl. G01N 21/00

(52) U.S. Cl. 422/57; 422/100

(57) ABSTRACT

In one embodiment, a tunable microfluidic device comprises at least one optical resonant cavity having a microfluidic channel disposed through a center thereof. At least one fluid is manipulated within the channel to change or “tune” an optical characteristic of the optical resonant cavity. In further embodiments, the tunable microfluidic device is incorporated into systems for assaying biological and/or chemical samples and for optical switching and/or filtering.

### CROSS REFERENCE TO RELATED APPLICATIONS

This application claims the priority of U.S. Provisional Patent Application No. 60/402,477, filed Aug. 9, 2002 (entitled “Microfluidic Tunable Ring Resonator Device for Optical Switching and Filtering”), and to U.S. Provisional Patent Application No. 60/402,321, filed Aug. 9, 2002 (entitled “Reagentless and Tagless Assay of Biological Samples Using Photonic Structures”), both of which are herein incorporated by reference.

### FIELD OF THE INVENTION

The present invention generally relates to the use of a tunable microfluidic device for optical switching, filtering and assaying of biological samples. For example, the present invention can be used in an optical switch in the telecommunications field, or in the detection of specific biological elements (e.g., cells, antibodies, proteins) in biological samples (e.g., organic tissues and blood).

### BACKGROUND OF THE INVENTION

Many special application devices are deployed in high technology industries such as telecommunications and medical and pharmaceutical applications. Many of these specially designed devices are used to address a particular condition. Thus, once they are deployed, they are no longer configurable or tunable to handle other conditions. Often, it is necessary to redeploy a new device that is designed to address a new condition. This lack of flexibility is costly and impractical.

For example, many medical and pharmaceutical applications require the identification, selection, and/or separation of cells and other biological applications from organic materials. For example, the use of stem cells for tissue and organ repair, as well as the use of leukocytes for control and treatment of oncological or autoimmune disorders, requires the selection and separation of specific cells from tissues or blood. Conventional techniques typically use reagents such as monoclonal antibodies and “tags” (e.g., fluorescent dyes) to identify and separate progenitor or white blood cells from the tissues or blood.

However, the reliability of such conventional techniques is limited because tagging a cell with a fluorescent dye will modify the cell, thereby potentially rendering the cell non-viable for therapeutic applications. A technique that enables the identification and separation of cells from tissues and blood, and enables the quantification of cell-cell, cell-protein and protein-protein interactions, without the direct use of tags or similar reagents would therefore be desirable, and would offer broad applications in the pharmaceutical industry.

Thus, there is a need for a technique for providing a tunable microfluidic device for optical switching, filtering, assaying of biological samples and the like.

### SUMMARY OF THE INVENTION

In one embodiment, a tunable microfluidic device comprises at least one optical resonant cavity having a microfluidic channel disposed through a center thereof. At least one fluid is manipulated within the channel to change or “tune” an optical characteristic of the optical resonant cavity. In further embodiments, the tunable microfluidic device is incorporated into systems for assaying biological and/or chemical samples and for optical switching and/or filtering.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of one embodiment of an optical resonant cavity for use in the tunable microfluidic device according to the teachings of the present invention;

FIG. 2 is a three-dimensional view of one embodiment of a tunable microfluidic device incorporating an optical resonant cavity such as that illustrated in FIG. 1;

FIG. 3 is a cross-sectional view of the tunable microfluidic device illustrated in FIG. 2;

FIG. 4 is a cross-sectional view of a second embodiment of a tunable microfluidic device according to the teachings of the present invention;

FIG. 5 is a cross-sectional view of a third embodiment of a tunable microfluidic device according to the teachings of the present invention;

FIG. 6 is a cross-sectional view of a fourth embodiment of a tunable microfluidic device according to the teachings of the present invention;

FIG. 7 is a three-dimensional view of a fifth embodiment of a tunable microfluidic device according to the teachings of the present invention;

FIG. 8 is a cross-sectional view of a sixth embodiment of a tunable microfluidic device according to the teachings of the present invention;

FIG. 9 is a cross-sectional view of a seventh embodiment of a tunable microfluidic device according to the teachings of the present invention;

FIG. 10 is a cross-sectional view of an eighth embodiment of a tunable microfluidic device according to the teachings of the present invention;

FIG. 11 is a cross-sectional view of a ninth embodiment of a tunable microfluidic device according to the teachings of the present invention;

FIG. 12 is a cross-sectional view of the tunable microfluidic device illustrated in FIG. 11, wherein fluid in the device is manipulated by a first method;

FIG. 13 is a cross-sectional view of the tunable microfluidic device illustrated in FIG. 11, wherein fluid in the device is manipulated by a second method;

FIG. 14 is a schematic illustration of a second embodiment of the method illustrated in FIG. 13;

FIG. 15 is a schematic illustration of one embodiment of a system incorporating a tunable microfluidic device according to the teachings of the present invention;

FIG. 16 is a schematic illustration of one embodiment of an interface for use with the system illustrated in FIG. 15;

FIG. 17 is a schematic illustration of one embodiment of a deflection system for use with the system illustrated in FIG. 15; and

FIG. 18 is a schematic illustration of a second embodiment of an interface for use with the system illustrated in FIG. 15.

To facilitate understanding, identical reference numerals have been used, where possible, to designate identical elements that are common to the figures.

### DETAILED DESCRIPTION

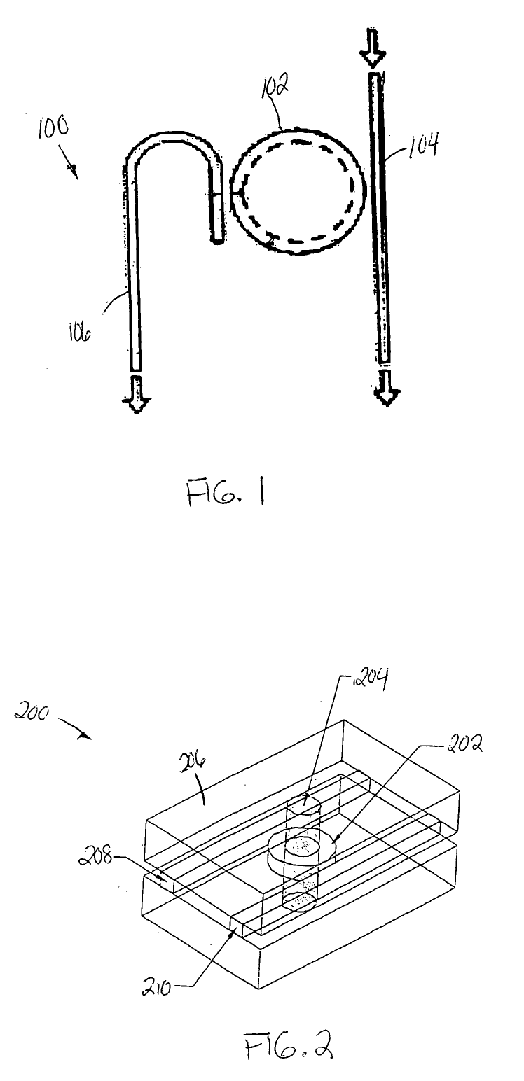

Embodiments of the invention generally incorporate a cavity waveguide, e.g., an optical resonant cavity, a ring waveguide, an optical reonsator or a ring resonator photonic structure, in a microfluidic apparatus to create a tunable device. FIG. 1 is a schematic illustration of a conventional ring resonator assembly 100. The ring resonator assembly 100 comprises a ring waveguide 102, an input waveguide 104 and an output waveguide 106. The input waveguide 104 carries input (e.g., light) that passes the ring waveguide 102. The ring waveguide 102 is configured such that when conditions for resonance are satisfied, the ring waveguide 102 will brighten with large energy. At the frequency or wavelength that satisfies the condition for resonance, the detected light intensity will increase abruptly. Therefore, the ring resonator assembly 100 may be configured so that only a pre-selected, narrow wavelength of light will “resonate” in the ring waveguide 102. The light that resonates within the ring waveguide 102 can then be optically coupled to the output waveguide 106.

In the present invention, the ring waveguide, or resonator, 102 is made tunable by altering a resonant property or condition of the ring waveguide 102. In one embodiment, a fluid is introduced within the cavity of the ring waveguide 102 to alter its resonant property or condition.

FIGS. 2 and 3 are three-dimensional and cross-sectional illustrations, respectively, of one embodiment of a tunable microfluidic device 200 incorporating a ring resonator. The device 200 comprises a cavity waveguide (e.g., an optical resonator, an optical resonant cavity, or a ring resonator) 202, an input waveguide 208, an output waveguide 210, a microfluidic channel 204, and a housing 206. As illustrated, the microfluidic channel is positioned concentrically within the cavity waveguide 202. A fluid having a pre-selected refractive index is passed through the microfluidic channel 204. The presence of fluid passing through the center of the cavity waveguide 202 will modify the optical propagation characteristics of the cavity waveguide 202 (i.e., the fluid will cause the resonator to change its optical coupling and transmission characteristics). In one embodiment, by introducing a fluid into the cavity (i.e., into the portion of the channel 204 that passes through the cavity waveguide 202), the resonant property or condition is changed such that the cavity waveguide 202 will resonate at a different frequency or wavelength. This flexibility allows the resonator to be tuned to a desirable frequency or wavelength to facilitate optical switching and filtering.

In addition, additives such as particles, chemicals, cells, antibodies or proteins that may be introduced in the fluid will also modify the optical propagation characteristics of the cavity waveguide 202. Therefore, the cavity waveguide 202 is configurable to detect changes in the refractive indices of fluid and/or matter passing through the microfluidic channel 204, thereby enabling efficient filtering or analysis of input. In one embodiment, the dimensions of the cavity waveguide 202 are on the order of tens of micrometers.

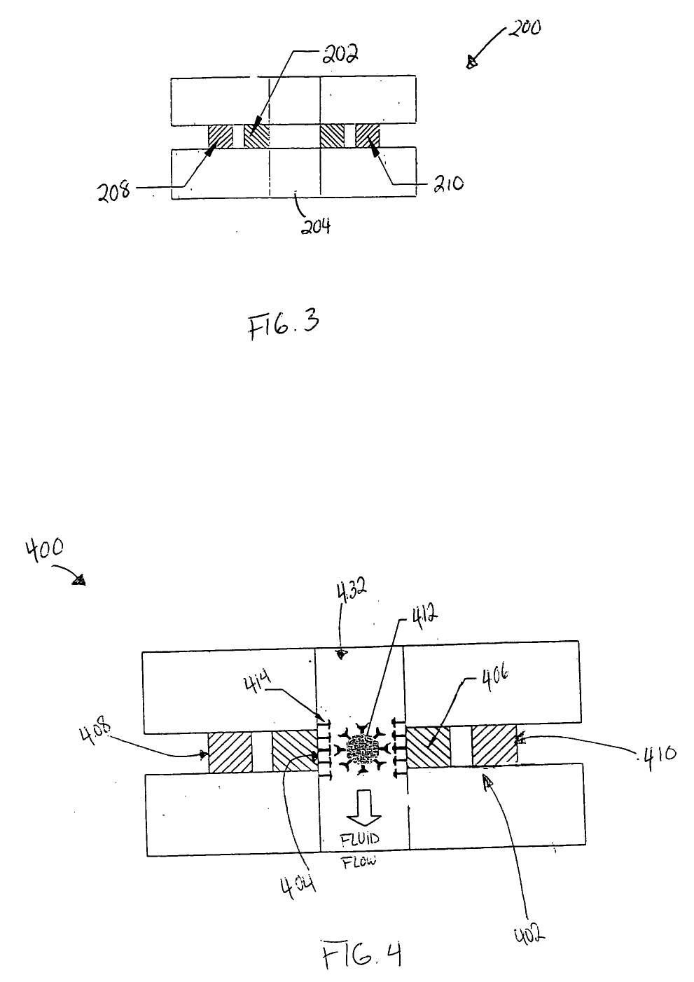

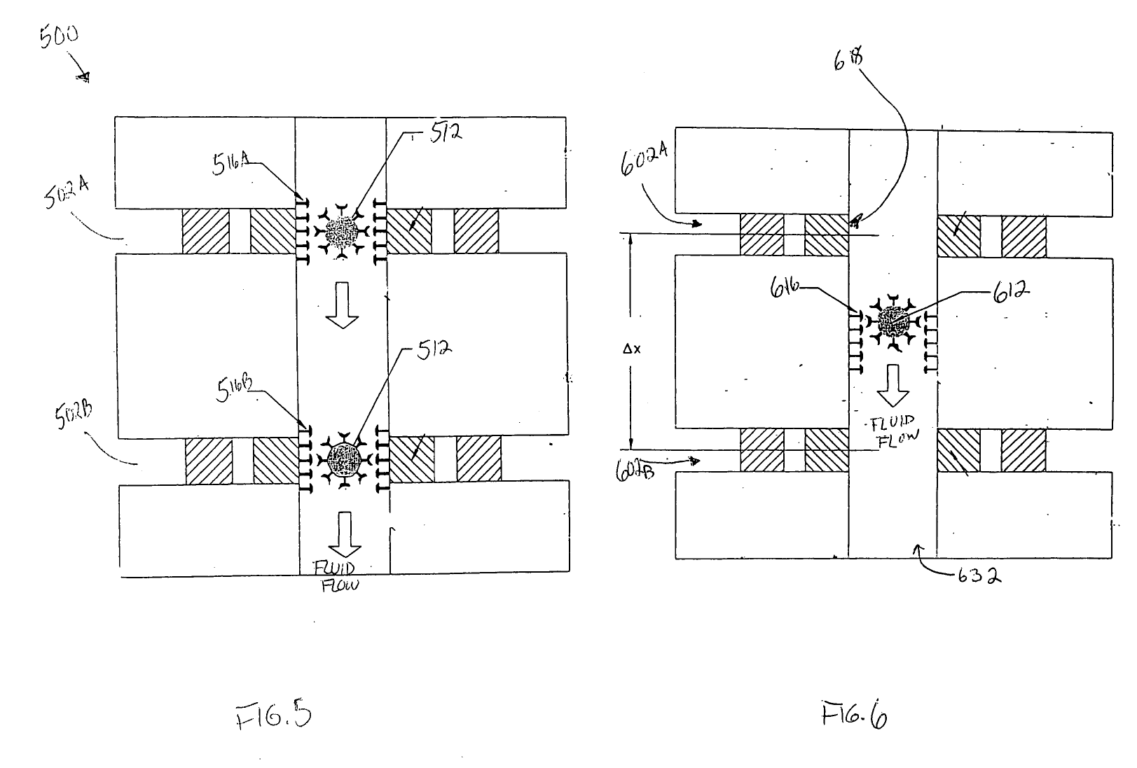

Tunable microfluidic devices such as that illustrated in FIGS. 2 and 3 may be incorporated in a variety of high-technology industries, including pharmaceutical and biotechnology applications. For example, FIG. 4 is a cross-sectional view of a second embodiment of a tunable microfluidic device 400 incorporating a resonator assembly 402. The resonator assembly 402 comprises a cavity waveguide 406, an input waveguide 408, an output waveguide 410, and a microfluidic channel 432 passing through a center of the cavity waveguide 406. The device 400 is similar to that illustrated in FIGS. 2 and 3; however, a specific binder 414 (e.g., a monoclonal antibody or ligand) is attached to the interior surface 404 of the cavity waveguide 406. Again, by binding to the specific binder 414, the additives 412 cause the refractive index to change in the cavity waveguide 406. This causes the cavity waveguide 406 to brighten or dim (depending on the specific application). By monitoring the effect on the cavity waveguide 406, the device 400 may be used to detect presence and/or the length of time that a particle (e.g., chemical compound) or cell 412 that is present in the fluid remains in the cavity waveguide's field of detection (i.e., the device 400 monitors the cell's “retardation time”). The retardation time represents the degree of interaction of the cell 412 with the specific binder 414 attached to the cavity waveguide 406. The incorporation of a specific binder 414 in the tunable device 400 therefore may enable broad applications in the assay of biological samples, including use in the identification and separation of biological elements (e.g., cells 412) with high and low degrees of interaction.

FIG. 5 illustrates a third embodiment of a tunable microfluidic device 500 in which two or more resonator assemblies 502 (i.e., resonator assemblies 502A and 502B) may be coupled in series to determine particle interactions against multiple specific binders 516A-B. Namely, the device 500 may comprise two or more resonator assemblies 502A-B, and each resonator assembly 502A-B may incorporate a different specific binder 516. Thus, two or more resonator assemblies 502A-B arranged in a “stack” may be employed to simultaneously detect multiple biological applications 512 within a single sample.

FIG. 6 illustrates a fourth embodiment of a tunable microfluidic device 600 comprising two or more resonator assemblies 602A, 602B (hereinafter collectively referred to as “resonator assemblies 602”) in which specific binders 616 are attached to the interior surface 618 of the microfluidic channel 632 in a region between the resonator assemblies 602. As the cell 612 passes the first resonator assembly 602A, its presence is detected by changing the resonant property at the first resonator assembly 602A. Next, the cell 612 is anticipated to interact with the binder 616 for a brief duration. Finally, the cell 612 disengages from the binder 616 and passes the second resonator assembly 602B, where its presence is again detected. Thus, the resonator assemblies 602 can be used to measure the time “Δt” that a cell 616 takes to travel the distance “Δx” from the first resonator assembly 602A to the second resonator assembly 602B.

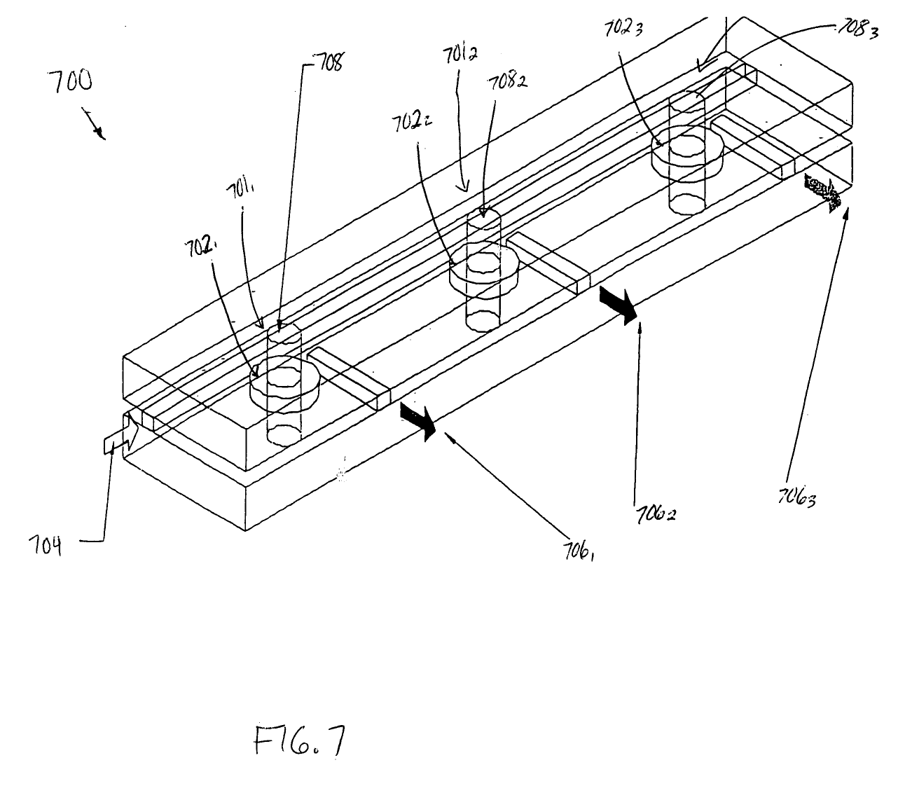

Tunable microfluidic devices may also be advantageously incorporated into an array. For example, FIG. 7 is a three-dimensional view of another embodiment of a tunable microfluidic device 700 in which two or more microfluidic resonator assemblies 701 are arranged in an array to re-route individual wavelengths to multiple outputs. In one embodiment, the tunable device 700 comprises two or more microfluidic resonator assemblies 701 (i.e., assemblies 701₁, 701₂ and 701₃) and a single input waveguide 704. Each microfluidic resonator assembly 701 comprises a cavity waveguide 702, a microfluidic channel 708 positioned concentrically within the cavity waveguide 702, and an output waveguide 706. The microfluidic resonator assemblies 701 are assembled in an array or a linear series, rather than stacked one upon another as illustrated in FIGS. 5 and 6. The single input waveguide 704 is positioned so that it is adjacent to all resonator assemblies 701 in the array. Although a plurality of output waveguides 706 are illustrated in FIG. 7, it should be noted that a single output waveguide 706 can be used as well.

Each microfluidic resonator assembly 701 is configured so that a different wavelength of light will resonate within each cavity waveguide 702 incorporated in the device 700 (e.g., so that each resonator assembly 701 may react to different resonant properties or conditions). This is accomplished largely by manipulation of the fluid within the microfluidic channel 708. Input (e.g., light) comprising a plurality of wavelengths enters the device through the input waveguide 704, which directs the input past each resonator assembly 701. Individual wavelengths within the input will resonate within different cavity waveguides 702 and will be re-directed to the output waveguides 706 of the respective resonator assemblies 701 within which the wavelengths resonate. Thus, this embodiment may be particularly suited for telecommunications applications such as optical switching. Fluids may be manipulated within the microfluidic channels 708 to make the device 700 reconfigurable in real time.

A microfluidic resonator device such as that described with reference to FIG. 7 may be “tuned” to switch, filter or re-direct optical beams with wavelength selectivity. Similarly, the array assembly of FIG. 7 can also be used in biological or chemical assay. A plurality of different fluids or additives can be simultaneously introduced into the plurality of microfluidic channels 708. This will allow rapid processing of a large amount of fluids to determine the presence/absence of an additive in the fluids.

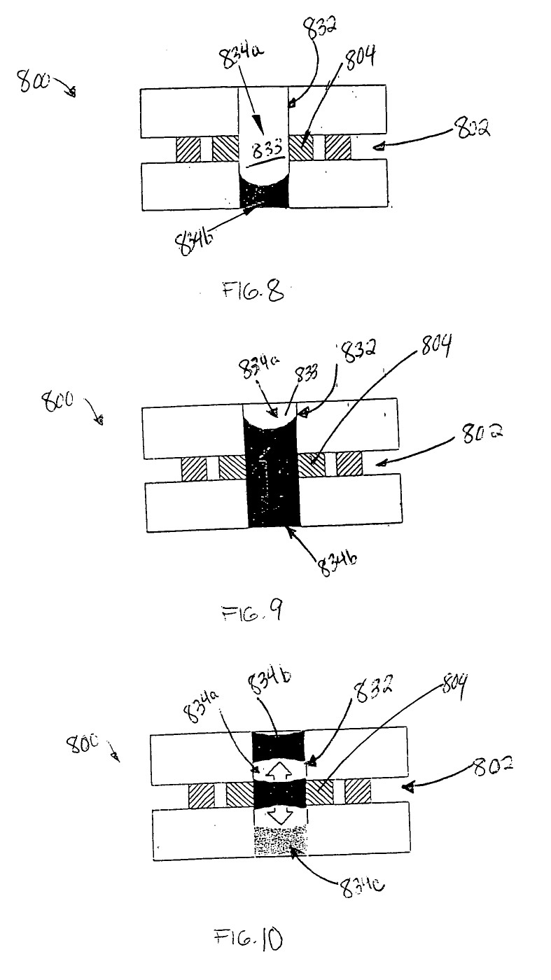

FIG. 8 is a cross sectional illustration of one embodiment, in which tuning is accomplished by manipulating the fluid(s) 834 in the microfluidic channel 832 to modify the resonant condition of the resonator assembly 802. Specifically, fluids 834 having different refractive indices in the microfluidic channel 832 will tune the resonator assembly 802. For example, FIGS. 8 and 9 are cross sectional illustrations of a resonator assembly 802 and microfluidic channel 832 containing, respectively, first and second fluid levels 834a and 834b (collectively referred to as “fluid(s) 834”). In one embodiment, the first fluid level 834a is below the resonator assembly 802 such that air is within the cavity 833 proximate the cavity waveguide 804. In a second embodiment, the fluid is caused to rise to a second fluid level 834b such that the cavity 833 is now filled with the fluid instead of air. As illustrated, the fluid level within the microfluidic channel 832 can be substantially altered to effect a change in the resonant property of the resonator assembly 802.

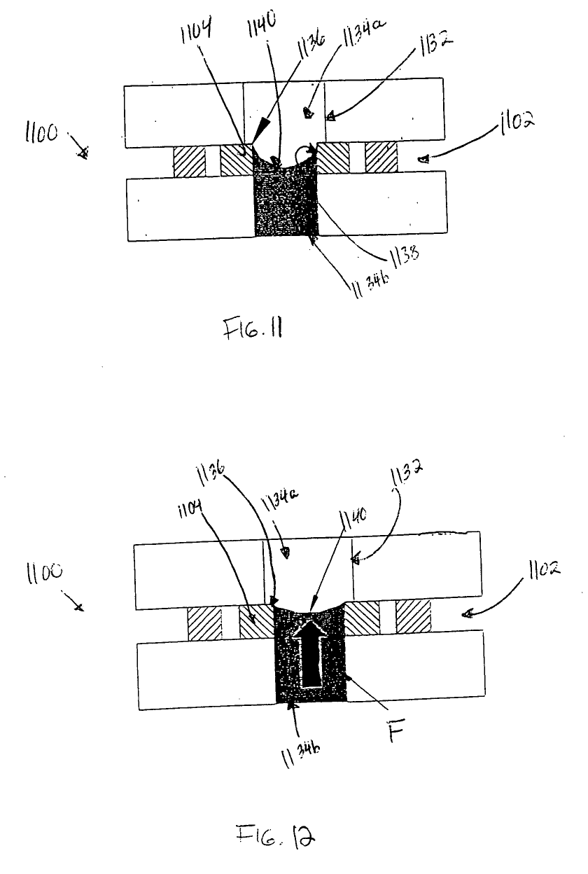

In further embodiments, two or more fluids 834 may be moved through the microfluidic channel 832, as illustrated in FIG. 10, in which three fluids 834a, 834b and 834c are moved through the microfluidic channel 832. Each of the fluids 834a-c will effect a different resonant property or condition.

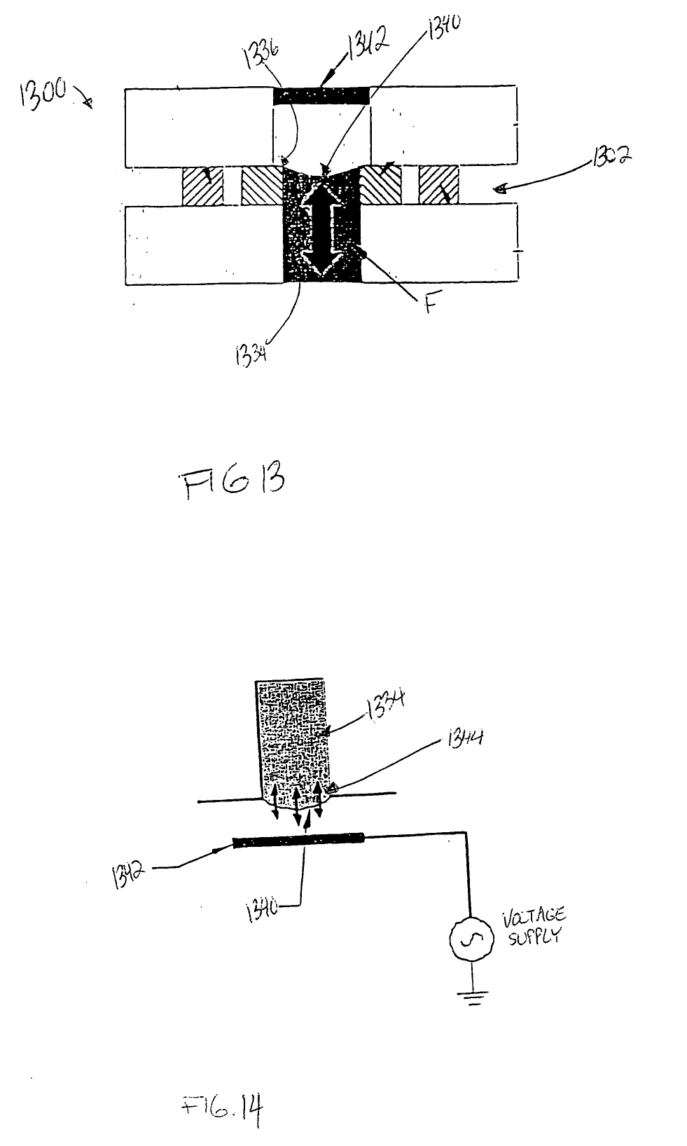

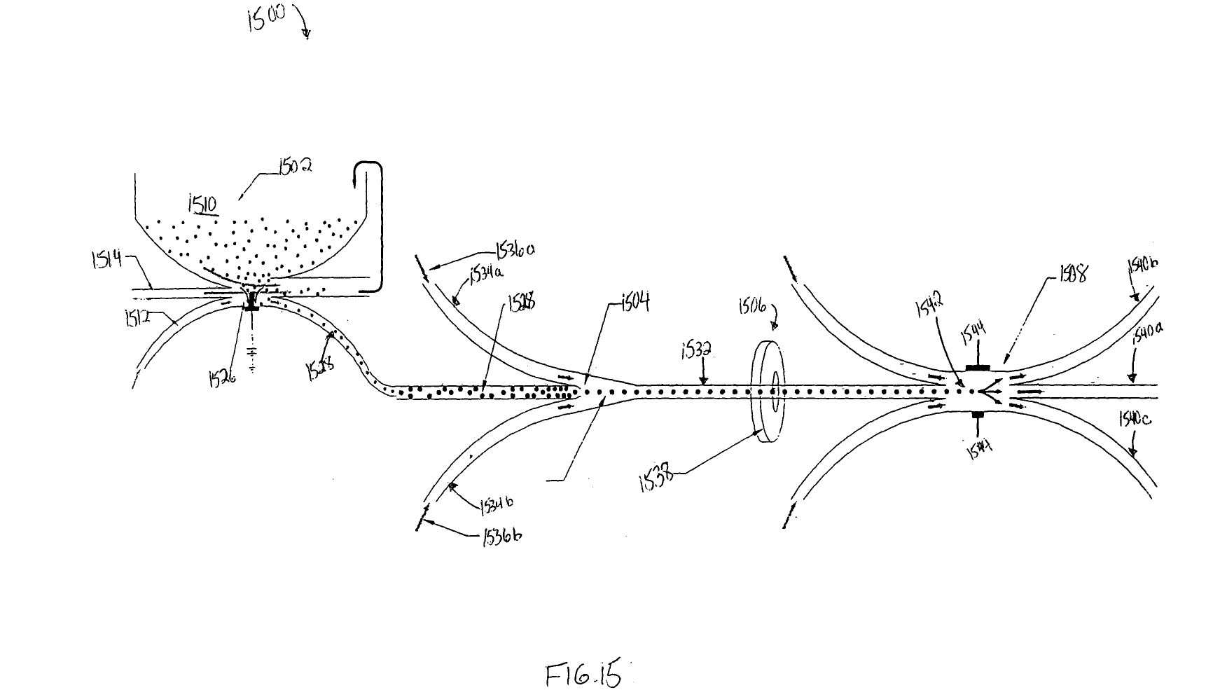

In one embodiment of a tunable resonator device 1100 illustrated in FIG. 11, the fluid or fluids 1134 in the microfluidic channel 1132 has a capillary break structure 1136 on the rim 1138 of the interior of the cavity waveguide 1104. Capillary breaks can stop fluid flow due to an interruption in capillary action. Force F may be applied to the fluid 1134, as illustrated in FIG. 12, to deform the fluid/air interface 1140 at the capillary break 1136. Deformation of the fluid with the assistance of capillary break 1136 will modify the resonant property of the detector of the resonator assembly 1102 (i.e., the optical transmission and resonant characteristics of the resonator assembly 1102 will be altered). As illustrated in FIG. 11, the force F applied to the fluid 1134 may be a physical force, or alternatively, as illustrated in FIGS. 13-14, the force F may be a dielectric force. In the embodiment illustrated in FIG. 13, a dielectric force actuator 1342 (i.e., an electrode) is incorporated into the device design to apply an electric field 1344 in a region of the fluid 1334 where there is a discontinuity in the dielectric constant (i.e., the capillary break 1336). The applied electric field will disturb the equilibrium state of the fluid/air interface 1340, thereby modifying the resonant property of the device 1300 in the proximity of the resonator assembly 1302.

In one embodiment, the tunable microfluidic device of the present invention (and particularly the embodiments described with reference to FIGS. 4-6) can be incorporated into a system for assaying and separating biological elements (e.g., cells) from a biological material sample, wherein the system relies on microfluidic transport of the biological material. Because the assay system is based on microfluidic structures, it may be easily incorporated into or housed within a compact device for easy use and transport. In one embodiment, a ring resonator photonic structure such as that described herein is incorporated into the system to facilitate identification of the biological applications within a sample being analyzed. One embodiment of the resonator is configured to detect changes in the refractive indices of cell surfaces, thereby enabling efficient identification and separation of cells with significant differences in surface composition, such as red and white blood cells. In a second embodiment, a specific binder may be incorporated into the resonator structure to detect the length of time a cell attenuates the resonance, i.e., “retardation time”, thereby enabling the identification and separation of cells with high and low degrees of interaction.

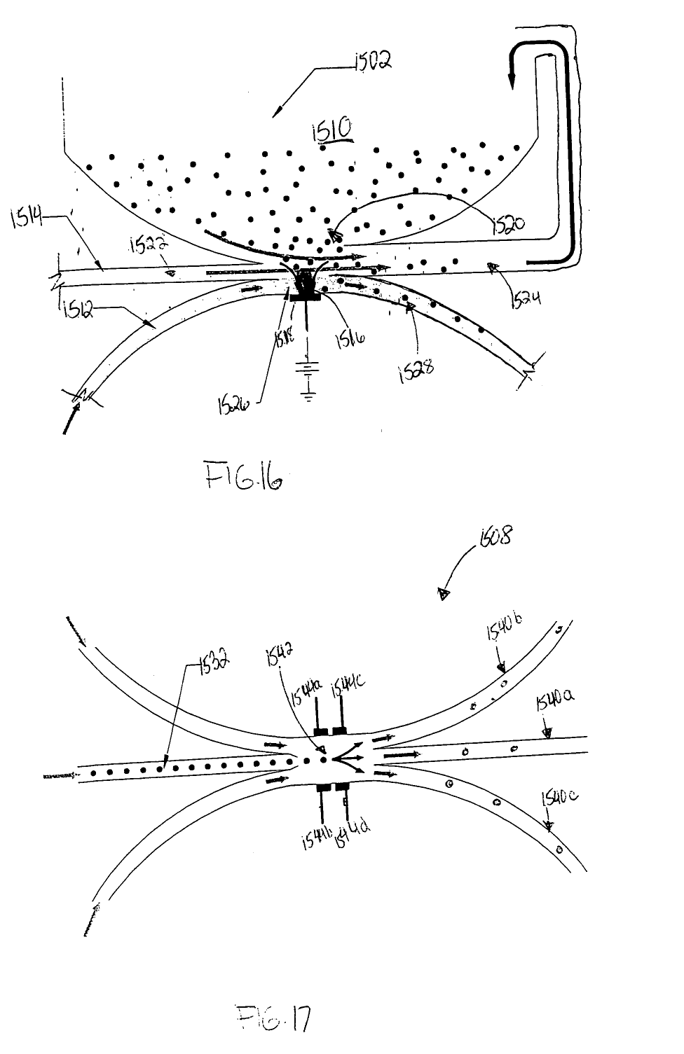

FIG. 15 is a schematic illustration of a biological processing system 1500 according to one embodiment of the present invention. The system 1500 comprises a macro-to-microfluidic sample input interface 1502, a biological element detection section 1506 and a biological and/or chemical element deflection section 1508. Optionally, the system 1500 also includes a biological focusing and reaction section 1504 positioned between the interface 1502 and the detection section 1506.

A common problem in microfluidic-based systems is the introduction of samples, e.g., cells, biomolecules, and chemical compounds, into a system. The system 1500 illustrated in FIG. 15 facilitates the introduction of biological samples into the system 1500 via a macroscopic sample input reservoir 1510 interfaced to a microfluidic channel 1512. Referring simultaneously to FIG. 15 and to FIG. 16, which is a more detailed schematic illustration of the sample input interface 1502 illustrated in FIG. 15, one embodiment of a sample input interface 1502 comprises a sample reservoir 1510, a re-circulation channel 1514, a microfluidic interface channel 1512, a detector section 1516 and at least two electrodes 1518a and 1518b. The sample reservoir 1510 is adapted to contain a suspension of biological and/or samples, which may be introduced into the reservoir by micro-pipetting, ink jet printing, or other means for small-volume transfers. The sample reservoir 1510 includes an aperture 1520 that is in fluid communication with the re-circulation channel 1514.

The re-circulation channel 1514 has an input portion 1522 and an output portion 1524, and is adapted to transport a buffer solution in a laminar flow that mixes with and transports the biological samples received from the sample reservoir 1510 via the aperture 1520. The input portion 1522 of the re-circulation channel 1514 introduces the buffer solution to the biological samples, so that the buffer solution may transport the samples past the detector section 1516 for analysis. The output portion 1524 of the re-circulation channel 1514 is adapted to transport used solution back to the sample reservoir 1510, and in one embodiment, the output portion 1524 has a larger volume than the input portion 1522 so that biological samples are pulled into the stream of the re-circulation channel 1514.

In a second embodiment illustrated in FIG. 18, the output portion 1524 is configured with a smaller volume than the input portion 1522. In one embodiment, the asymmetric dimensioning of the input and output portions 1522, 1524 of the re-circulation channel 1514 creates a vortex in the sample reservoir 1510 that helps to maintain the biological samples in the suspension contained in the reservoir 1510.

Proximate to the aperture 1520 in the sample reservoir 1510, the re-circulation channel 1514 forms an interface 1526 with the laminar flow in the microfluidic interface channel 1512. The channel interface 1526 is the only point in the system at which the laminar fluid flows transported within the two channels 1512, 1514 mix, by diffusion. This effect is exploited to maintain the fluid transported in the re-circulation channel 1514 within the re-circulation channel 1514, so that substantially only biological samples transported therein will cross over into the microfluidic interface channel 1512 when a force is applied.

The detector 1516 is positioned proximate to the channel interface 1526 to detect the presence of biological elements in the samples that flow past in the re-circulation channel 1514. The detector 1516 may be an optical detector (such as a light scattering or fluorescence detector, among others), or it may be an electrical detector (such as a capacitance detector, among others). In the illustrated embodiment, the detector 1516 is a tunable microfluidic device such as any of those illustrated in FIGS. 2-6.

Biological elements that pass through the field of view of the detector 1516 are re-directed from the fluid stream in the re-circulation channel 1514 into the microfluidic interface channel 1512 to form a stream 1528 of biological elements. In one embodiment, re-direction of biological elements is accomplished by establishing electrohydrodynamic forces within the system. In the embodiment illustrated in FIGS. 15 and 16, a first electrode 1518a is positioned near the microfluidic interface channel 1512, and a second electrode 1518b is grounded, and an electric field is applied between the electrodes 1518a, 1518b to establish the electrohydrodynamic forces. In one embodiment, the dominant electrohydrodynamic force is a dielectrophoretic force that acts on a dielectric material (e.g., the biological samples) located in the electric field gradient.

Referring back to FIG. 15, once biological elements have been introduced into the microfluidic analysis system 1500 and separated into the microfluidic interface channel 1512, the elements may be transported downstream for individual analysis and separation. The microfluidic interface channel 1512 of the sample input interface 1502 is coupled to the biological element focusing and reaction section 1504, which comprises at least one transport channel 1532 for transporting biological elements. The at least one transport channel 1532 has a volume that is small enough to allow approximately only a single biological element to freely pass through the channel 1532. In one embodiment, fluids and biological samples are urged through the transport channel 1532 by at least one of electrohydrodynamic pumping, magnetohydrodynamic pumping, pressure pumping, electroosmotic pumping, electrophoresis, thermocapillarity and electrowetting. In further embodiments, the focusing and reaction section 1504 also includes one or more optional lateral channels 1534 that interface with the transport channel 1532 for transporting one or more assay reagents 1536 for reaction with the biological elements prior to entering the transport channel 1532.

The transport channel 1532 transports the biological elements, substantially single-file, to the detection section 1506, which comprises a detector 1538 located proximate to the transport channel 1532. The detector 1538 is adapted to observe the biophysical properties and chemical interactions of the biological elements that pass through the field of detection, and the detector 1538 transmits this information as output in the form of a control signal to the deflection section 1508. Analysis by the detector 1538 may be accomplished by light scattering, fluorescence spectroscopy, colorimetry, fluorescence polarization, or surface plasmon resonance, among other means. In the embodiment illustrated in FIG. 15, the detector 1538 is a tunable microfluidic device such as any of those described with reference to FIGS. 2-6.

The deflection section 1508 is coupled to a portion of the transport channel 1532 that is located downstream from the detection section 1506 and comprises at least two diverging channels 1540 and an electric field 1542 established by two or more electrodes 1544. The electric field 1542 is applied perpendicular to the flow in the transport channel 1532 and exerts an electrohydrodynamic force (such as a dielectrophoretic or dielectric force) on the biological elements within the transport channel 1532.

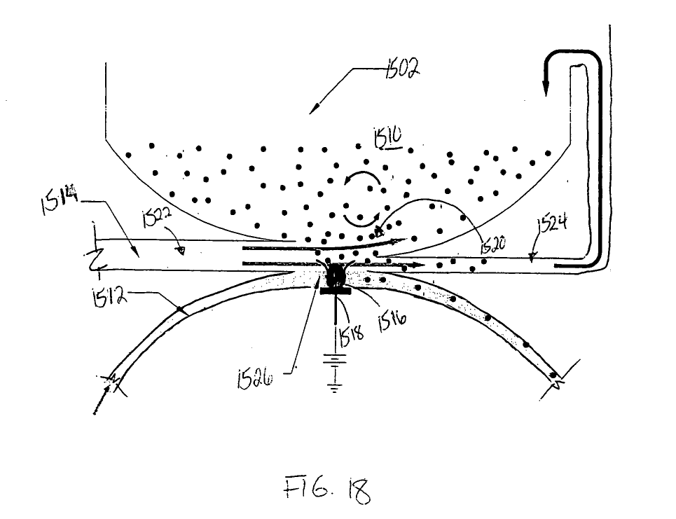

A more detailed schematic illustration of the deflection section 1508 is shown in FIG. 17. In the illustrated embodiment, the deflection section 1508 includes four electrodes 1544a-d (hereinafter collectively referred to as “electrodes 1544”) that are adapted to generate asymmetric electric fields 1542 by applying different potentials between each electrode 1544. For example, electrodes 1544a and 1544c may be tied together, and a potential may be applied with respect to electrode 1544b. In the illustrated embodiment, the asymmetric electric field 1542 is adapted to direct the biological elements in the transport channel 1532 into one of three different diverging channels 1542a-c. Although the deflection section 1508 illustrated in FIGS. 15 and 17 comprises three channels 1542a-c, it will be appreciated that less or more channels may be used to advantage without departing from the scope of the invention. In further embodiments, an incubation section (not shown) can be incorporated into the system for biological elements that require incubation (for example, a long channel such as a serpentine with a temperature-controlled heater may be incorporated). The system 1500 therefore may be implemented to facilitate the efficient identification and separation of cells from tissues and blood without the use of reagents or tags that may bind themselves to the cells. Furthermore, the present invention enables the quantification of cell-cell and cell-protein interactions without the use of reagents, and the applications of such abilities are particularly broad and significant in the pharmaceutical industry.

Thus, the present invention represents a significant advancement in the field of switching, filtering and biological and/or chemical element detection technology. A method and apparatus are provided that enable tunable switching, filtering and assay applications in microfluidic devices. The present invention has broad potential applications, particularly in the fields of telecommunications, pharmaceuticals and biotechnology.

While the foregoing is directed to embodiments of the invention, other and further embodiments of the invention may be devised without departing from the basic scope thereof, and the scope thereof is determined by the claims that follow.

What is claimed is:

1. A tunable device comprising:
at least one input waveguide;
at least one cavity waveguide in communication with the at least one input waveguide;
at least one output waveguide in communication with the at least one cavity waveguide; and
at least one channel disposed through a center of the at least one cavity waveguide for carrying at least one fluid.

2. The tunable device of claim 1, wherein said at least one cavity waveguide comprises:
two or more cavity waveguides arranged in a series; and
wherein said at least one channel is disposed through the centers of each of the two or more cavity waveguides.

3. The tunable device of claim 2, wherein each of the two or more cavity waveguides has a different resonant property.

4. The tunable device of claim 1, wherein said at least one cavity waveguide comprises:
two or more cavity waveguides arranged in an array; and
wherein said at least one channel comprises two or more channels, wherein each of the two or more cavity waveguides has one of said channels disposed through its center.

5. The tunable device of claim 4, wherein each of the two or more cavity waveguides has a different resonant property.

6. The tunable device of claim 4, wherein said at least one fluid disposed within each of the two or more channels has different optical properties.

7. The tunable device of claim 1, further comprising:
at least one binder attached to an interior surface of at least one cavity waveguide.

8. The tunable device of claim 2, further comprising:
at least one binder attached to an interior surface of at least one of the two or more cavity waveguides.

9. The tunable device of claim 8, wherein said at least one binder comprises different binders that are attached to the interior surfaces of each of the two or more cavity waveguides.

10. The tunable device of claim 2, further comprising:
at least one binder attached to an interior surface of at least a portion of the channel located between two cavity waveguides.

11. The tunable device of claim 10, wherein said at least one binder comprises different binders that are attached to the interior surfaces of two or more portions of the channel.

12. The tunable device of claim 1, wherein said at least one fluid comprises two or more fluids that are contained within the at least one channel, where each of the two or more fluids has a different refractive index.

13. The tunable device of claim 1, wherein the at least one cavity waveguide has dimensions on the order of tens of micrometers.

14. The tunable device of claim 1, further comprising:
a dielectric force actuator for manipulating the at least one fluid contained within the at least one channel.

15. A method for tunable optical switching, comprising the steps of:
providing a signal to an input waveguide;
providing a plurality of cavity waveguides along said input waveguide, wherein each of said cavity waveguides has a channel disposed through a center of said cavity waveguide;
providing at least one output waveguide in communication with said plurality of cavity waveguides; and
passing at least one fluid through at least one of said channels to effect switching of said signal from said input waveguide to at least one output waveguide.

16. The method of claim 15, wherein said fluid disposed within each of said channels has different optical properties.

17. The method of claim 15, wherein said at least one fluid comprises two or more fluids having different optical properties that can be passed through each of said channels.

18. The method of claim 15, further comprising the step of:
providing a capillary break in at least one of said channels.

19. The method of claim 18, wherein the capillary break is disposed proximate to said cavity waveguide.

20. A method for assaying samples, the method comprising the steps of:
providing a signal to an input waveguide;
providing at least one cavity waveguide along said input waveguide, wherein each of said at least one cavity waveguides has a channel disposed through a center of said cavity waveguide;
providing at least one output waveguide in communication with said at least one cavity waveguide; and
passing at least one fluid through at least one of said channels to effect a change in the resonant properties of the at least one cavity waveguide, wherein the at least one fluid contains said sample.

21. The method of claim 20, wherein said fluid disposed within said at least one channel comprises two or more fluids that have different optical properties.

22. The method of claim 20, further comprising:
adding at least one assay reagent to said at least one fluid.

23. The method of claim 20, further comprising:
attaching a binder to an interior surface of at least one of said at least one cavity waveguides.

24. The method of claim 23, wherein the binder interacts with said sample in said at least one fluid.

25. The method of claim 20, further comprising:
attaching a binder to an interior surface of at least a portion of at least one of said channels, the portion residing between two cavity waveguides.

26. The method of claim 20, further comprising:
providing a capillary break in at least one of said channels.

27. The method of claim 26, wherein the capillary break is disposed proximate to said cavity waveguide.

28. A system for assaying samples, the system comprising:
an interface section, for introducing the samples into the system; and
a detection section, for analyzing one or more elements within the samples.

29. The system of claim 28, further comprising:
a deflection section, for sorting analyzed elements.

30. The system of claim 28, further comprising:
a focusing section for providing at least one reagent to the samples prior to analysis.

31. The system of claim 28, wherein the interface section comprises:
a sample reservoir for containing the samples, wherein the sample reservoir has an aperture;
a re-circulation channel in fluid communication with the sample reservoir for receiving said samples from the sample reservoir;
a detector positioned proximate to the re-circulation channel for separating elements out of the samples contained in the re-circulation channel; and
an interface channel in fluid communication with the re-circulation channel, for delivering the separated elements to a detection section.

32. The system of claim 31, wherein the re-circulation channel comprises:
an input portion for delivering a buffer solution for transporting the samples received from the sample reservoir; and
an output portion for delivering the buffer solution into the sample reservoir.

33. The system of claim 32, wherein the input and output portions of the recirculation channel are asymmetrically dimensioned relative to each other.

34. The system of claim 31, wherein the detector is at least one of an optical or electrical detector.

35. The system of claim 31, further comprising at least one electrode positioned proximate to the interface channel for creating an electric field.

36. The system of claim 30, wherein the focusing section comprises at least one transport channel for transporting said separated elements in a substantially single-file stream.

37. The system of claim 36, wherein the focusing section further comprises at least one lateral channel coupled to the transport channel for delivering said at least one reagent to the stream of separated elements.

38. The system of claim 36, wherein the separated biological elements are urged through the transport channel by at least one of electrohydrodynamic pumping, magnetohydrodynamic pumping, pressure pumping, electroosmotic pumping, electrophoresis, thermocapillarity and electrowetting.

39. The system of claim 28, wherein the detection section comprises a detector for analyzing the elements using at least one of light scattering, fluorescence spectroscopy, colorimetry, fluorescence polarization and surface plasmon resonance.

40. The system of claim 39, wherein the detector comprises at one least resonator assembly comprising:
at least one input waveguide;
at least one cavity waveguide in communication with the at least one input waveguide;
at least one output waveguide in communication with the at least one cavity waveguide; and
at least one transport channel disposed through a center of the at least one cavity waveguide for carrying said elements in at least one fluid.

41. The system of claim 40, further comprising:
at least one assay reagent disposed in said at least one transport channel.

42. The system of claim 40, wherein the dimensions of said at least one resonator assembly are on the order of tens of micrometers.

43. The system of claim 40, further comprising:
a binder attached to an interior surface of said at least one cavity waveguide.

44. The system of claim 40, further comprising:
two or more binders attached to interior surfaces of two or more cavity waveguides.

45. The system of claim 40, further comprising:
at least one binder attached to an interior surface of at least a portion of said transport channel, the portion residing between two cavity waveguides.

46. The system of claim 40, wherein said at least one cavity waveguide further comprises a dielectric force actuator for modifying the refractive index of said cavity waveguide.

47. Apparatus for interfacing a macrofluidic input source with a microfluidic system, comprising:
a reservoir for containing at least one input sample, wherein the reservoir has an aperture;
a re-circulation channel in fluid communication with the reservoir for receiving said at least one input sample from the reservoir;
a detector positioned proximate to the re-circulation channel for separating at least one element out of the at least one input sample contained in the recirculation channel; and
an interface channel in fluid communication with the re-circulation channel, for delivering at least one separated element to said microfluidic system.

48. Apparatus for sorting at least one element in a fluid-based sample, comprising:
at least one input channel;
two or more output channels coupled to the at least one input channel at a channel interface;
one or more electrodes positioned proximate to the channel interface for urging said at least one element into one of the two or more output channels.
